(19) United States
(12) Patent Application Publication
(10) Pub. No.: US 2024/0416256 A1
(43) Pub. Date: Dec. 19, 2024

(54) METHOD, SYSTEM, AND DEVICES FOR WATER, ORGANICS, AND/OR MINERAL RECOVERY

(71) Applicant: The Trustees of Princeton University, Princeton, NJ (US)

(72) Inventors: Sunxiang ZHENG, Edison, NJ (US); Xi CHEN, Princeton, NJ (US); Zhiyong Jason REN, Princeton, NJ (US)

(73) Assignee: The Trustees of Princeton University, Princeton, NJ (US)

(21) Appl. No.: 18/712,454

(22) PCT Filed: Nov. 23, 2022
(86) PCT No.: PCT/US2022/050915

§ 371 Date: May 22, 2024

Related U.S. Application Data
(60) Provisional application No. 63/282,429, filed on Nov. 23, 2021.
(60) Provisional application No. 63/335,766, filed on Apr. 28, 2022.

(51) Int. Cl. B01D 1/00; B01D 5/00; B01D 9/00; C01D 3/06; C01D 15/04; C01D 15/08; C22B 26/12

(52) U.S. Cl. CPC B01D 1/0035; B01D 1/0017; B01D 5/006; B01D 9/0031; C01D 3/06; C01D 15/04; C01D 15/08; C22B 26/12; B01D 2009/0086

(57) ABSTRACT

A process for water, mineral, and/or organics recovery, as well as devices and systems that practice the process, are disclosed. The process may include providing a plurality of evaporator structures, each structure physically separated from the others, and contacting the first end of each evaporator structure with a liquid containing a plurality of materials (such as a solvent and one or more minerals). The process may include allowing capillary forces and siphonic action to draw at least one material of the plurality of materials (which may be, e.g., the solvent, a volatile organic material, and/or a mineral) from the first end towards the second end, and evaporating one or more of the plurality of materials by transferring at least one form of environmental energy (such as solar energy, wind energy, and/or ambient heat of air) directly to each evaporator structure, thereby providing the latent heat of vaporization.

### CROSS-REFERENCE TO RELATED APPLICATIONS

The present application claims priority to U.S. Provisional Patent Application Nos. 63/282,429, filed Nov. 23, 2021, and 63/335,766, filed Apr. 28, 2022, the entirety of which are incorporated by reference herein in their entirety.

### TECHNICAL FIELD

The present disclosure is related to material recovery, and specifically to techniques with low energy costs for recovering a desired material from a liquid using porous elongated structures.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As readily available natural resources continue to decline, alternative techniques for extracting such resources are a necessary critical component of any sustainable system. Unfortunately, conventional techniques, including the popular solar-driven water evaporation and water harvesting, have some major challenges, including intermittent operation, low water production rate, and system scaling.

### BRIEF SUMMARY

Various deficiencies in the prior art are addressed below by the disclosed compositions of matter and techniques.

In some embodiments, a process for water, organics, and/or mineral recovery may be provided. The process may include providing a plurality of evaporator structures, such as two-dimensional or three-dimensional evaporator structures, comprising a porous material, each evaporator structure having a first end and a second end opposite the first end separated by an axial length, each evaporator structure being physically separated from an adjacent evaporator structure. The process may include contacting the first end of each evaporator structure with a liquid, the liquid comprising a plurality of materials, the plurality of materials including a solvent and at least one target material at a first concentration. The process may include allowing capillary forces or siphonic action to draw at least one material of the plurality of materials (which may be, e.g., a volatile organic material or a mineral) from the first end towards the second end. The process may include evaporating one or more of the plurality of materials by transferring at least one form of environmental energy (such as solar energy, wind energy, and/or ambient heat of air) directly to each evaporator structure, thereby providing the latent heat of vaporization. In some embodiments, evaporating occurs under ambient temperature conditions. In some embodiments the evaporating occurs at temperatures above 50° C.

In some embodiments, the process may include collecting the at least one target material after the at least one target material passes from the first end to the second end. In some embodiments, the process may include determining a concentration of the at least one target material being collected. In some embodiments, the process may include adjusting a distance from the second end to a collection reservoir based on determined concentration.

In some embodiments, each evaporator structure may include a plurality of fibers twisted around each other to form a spiral pattern having at least a first pitch, and wherein the process further comprises adjusting a pore size of at least a portion of a evaporator structure of the plurality of evaporator structures by rotating a first portion of the evaporator structure around a central axis relative to a second portion of the evaporator structure, causing the first pitch to be changed to a second pitch different from the first pitch.

In some embodiments, the liquid may be a saline water source. In some embodiments, the saline water source may be seawater, brine lake water, reservoir water, groundwater, geothermal brine, or wastewater. In some embodiments, the process may include collecting water as a vapor or a liquid.

In some embodiments, the at least one material is water, and the process may include capturing and condensing the water. In some embodiments, the liquid may include a plurality of salts. In some embodiments, the plurality of salts may include a first salt comprising a targeted mineral, and a second salt. In some embodiments, the target mineral may be lithium. In some embodiments, the liquid may include lithium, silver, gold, nickel, cobalt, copper, aluminum, iron, zinc, molybdenum, boron, potassium, sodium, calcium, magnesium, manganese, selenium, platinum, uranium, silica, or a combination thereof. In some embodiments, the liquid may include an industrial stream. In some embodiments, the industrial stream may include an organic solvent, an ionic liquid, and/or another industrial stream. In some embodiments, the liquid may include an organic solvent, a volatile fatty acid, or a combination thereof.

In some embodiments, the process may include allowing the capillary forces or siphonic action to spatially separate salts in the liquid by their differences in solubility, hydrophilicity, and local concentration.

In some embodiments, the process may include evaporating water and crystallizing the plurality of salts in or on the porous crystallizer, where salts with lower solubility are crystallized within a first distance from the first end, while salts with a higher solubility are crystallized after the first distance and before a second distance from the first end, the second distance being greater than the first distance, such that different salts precipitate sequentially on the crystallizer structure with both radial and axial structures. In some embodiments, the process may include collecting the first salt that crystallize at or near the second end, and separately collecting the second salt that crystalize at or near the first end. In some embodiments, the process may include separating at least a portion of a salt shell at or near the second end from a remainder of a salt shell formed around the evaporator structure. In some embodiments, the process may include removing the remainder of the shell from the evaporator structure.

In some embodiments, the porous material may include at least one of wood materials, plant-based fabrics, modified plant-based materials, unmodified plant-based materials, and a polymer.

In some embodiments, the process may include pretreating the porous material with an alkaline solution at a concentration of 0.5-2.5 M. In some embodiments, the process may include heating the porous material to 70-200 degrees Celsius for 1-10 hours to partially remove one or more impurities. In some embodiments, the process may include freeze-drying the porous material for 12-48 hours. In some embodiments, the process may include surface carbonizing the porous material by pressing and rolling the porous material on a hot plate until an external surface of the porous material is uniformly carbonized.

In some embodiments, the evaporating may include causing air to pass around and/or through each evaporator structure. In some embodiments, the evaporating may include allowing a light source to irradiate the evaporator structure. In some embodiments, evaporating one or more of the plurality of materials may include allowing a salt shell formation around the evaporator structure.

In some embodiments, each evaporator structure may have an axial length of at least 1 meter. In some embodiments, each evaporator structure may have a length-to-radius ratio of at least 10:1 and is positioned substantially vertically. In some embodiments, the plurality of evaporator structures may be arranged in an array.

In some embodiments, the process may include generating an electrical field, and applying the electric field to the plurality of evaporator structures. In some embodiments, the process may include removing at least one of the evaporator structures from the liquid. In some embodiments, the process may include washing each evaporator structure that has been removed. In some embodiments, the process may include, after being washed, re-coupling the first end of each evaporator structure to the liquid. In some embodiments, the process may include placing the first end of a new evaporator structure into the liquid after the at least one of the evaporator structures has been removed from the liquid. In some embodiments, removing at least one of the evaporator structures from the liquid may include simultaneously removing two or more of the plurality of evaporator structures from the liquid.

In some embodiments, an apparatus for water, organic, and/or mineral recovery is provided. The apparatus may include a plurality of evaporator structures, each evaporator structure comprising a porous material, each evaporator structure having a first end and a second end opposite the first end separated by an axial length, each evaporator structure being physically separated from an adjacent evaporator structure, where each evaporator structure has a porous structure configured to use capillary forces or siphonic action to draw a liquid from the first end towards the second end. The apparatus may be configured to allow at least one form of environmental energy to be transferred directly as latent heat for vaporization to each evaporator structure.

In some embodiments, each evaporator structure comprises a plurality of elongate members, each elongate member being twisted together to form a spiral structure. In some embodiments, each evaporator structure may include a rigid elongate member having a stiffness greater than that of the porous material, the porous material being twisted around the rigid member in a spiral pattern. In some embodiments, each evaporator structure may include a weighted member operably coupled to either the first end or the second end of the evaporator structure. In some embodiments, each evaporator structure may have an inner pore structure that is hydrophilic, and an outer surface that is hydrophobic. In some embodiments, each evaporator structure may be composed of natural wood materials, polymers, ceramics, porous carbons, geopolymers, hydrogel, textiles, or a combination thereof. In some embodiments, each evaporator structure may be composed of natural wood materials, twisted fibers from natural materials, or a combination thereof. In some embodiments, each evaporator structure may have a substantially identical geometry. In some embodiments, at least one of the plurality of evaporator structures may have a different geometry. In some embodiments, each evaporator structure may define a geometry that is substantially cylindrical, spiral, pyramidal, conical, prism, or rectangular. In some embodiments, at least one of the plurality of evaporator structures may define a spiral geometry, the at least one of the plurality of evaporator structures comprises natural cotton or plant fiber. In some embodiments, the at least one of the plurality of evaporator structures may include a bundle of plant fibers spun into a yarn with a diameter of 1 mm, and 4 yarns are further twisted into 1 cord with a diameter of 2 mm. In some embodiments, each evaporator structure may have a surface modification configured to reduce the effect of foulants. In some embodiments, each evaporator structure has a surface modification configured to reduce the effect of foulants, each evaporator structure may have an axial length of at least 1 meter. In some embodiments, each evaporator structure may be substantially cylindrical, and may have a length-to-radius ratio of at least 10:1.

In some embodiments, the apparatus may include a frame operably coupled to the first end and/or the second end of each of the plurality of evaporator structures. In some embodiments, the frame may have a cross-section defined by an annulus. In some embodiments, the frame may be configured to position the first end of each of the plurality of evaporator structures to be below a surface of a liquid. In some embodiments, the frame may be configured to position each evaporator structure in a substantially vertical position.

In some embodiments, a system may be provided. The system may include an apparatus for water, organic, and/or mineral recovery as disclosed herein, and a liquid. The first end of each evaporator structure may be operably coupled to the liquid, such as being positioned in the liquid. In some embodiments, the system may include a container configured to hold the liquid. In some embodiments, the system may include a pump configured to pump the liquid from a liquid source to the container. In some embodiments, the system may include at least one processor configured to control the pump. In some embodiments, the system may include a fan configured to direct air across each evaporator structure. In some embodiments, the system may include a housing configured to surround at least a portion of the apparatus. In some embodiments, the system may include a collection container configured to collect at least one target material present in the liquid after the at least one target material passes from the first end to the second end of at least one evaporator structure. In some embodiments, the system may include an electric field generator configured to expose each evaporator structure to a electric field.

In some embodiments, a kit may be provided. The kit may include a plurality of evaporator structures as disclosed herein, and a frame configured to be coupled to the plurality of evaporator structures.

In some embodiments, a evaporator structure may be provided. The evaporator structure may include a plurality of flexible elongate members, each flexible elongate member twisted together to form a spiral pattern, each flexible elongate member comprising a porous material, each flexible elongate member having a first end and a second end opposite the first end and separated by an axial length, the porous material being configured to use capillary forces or siphonic action to draw a liquid from the first end towards the second end;
wherein each flexible elongate member has an axial length of at least one meter. In some embodiments, the evaporator structure has an inner pore structure that is hydrophilic, and an outer surface that is hydrophobic. In some embodiments, the evaporator structure may include at least one connector coupled to the first end of the evaporator structure. In some embodiments, the evaporator structure may be composed of natural wood materials, polymers, ceramics, porous carbons, geopolymers, or a combination thereof. In some embodiments, the evaporator structure may be composed of natural wood materials, twisted fibers from natural materials, or a combination thereof. In some embodiments, the evaporator structure may include a rigid elongate member having a stiffness greater than that of each flexible elongate member. In some embodiments, each flexible elongate member may be twisted around the rigid member in the spiral pattern. In some embodiments, the evaporator structure may include a weighted member operably coupled to either the first end or the second end of the evaporator structure.

### BRIEF DESCRIPTION OF THE FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIGS. 1A-1B are flowcharts describing of one embodiment of a process.

FIGS. 2A-2F are illustrations of embodiments of a evaporator structure.

FIGS. 3A-3B are illustration of embodiments of a system.

FIG. 3C is an illustration of an embodiment of a connector coupled to a evaporator structure.

FIG. 3D is a simplified cross-sectional side view of an embodiment of a system.

FIG. 4 is a simplified cross-sectional side view showing a salt shell formed around a evaporator structure.

FIG. 5 is an illustration of one embodiment of evaporator structures being used in series.

FIG. 6A is a graph illustrating the spatial separation and extraction process of lithium from other minerals using an embodiment of evaporator structures.

FIG. 6B is a graph showing an average >100-times concentration of LiCl from Li-brine.

FIG. 6C is a graph showing an average >5000-times concentration of LiCl from seawater.

FIG. 6D is a graph showing evaporation rates (E.R.) achieved using an embodiment of the disclosed evaporators with standard, 1-Sun-incidence, and 0.5 m/s wind aided conditions.

FIGS. 7A and 7B are graphs showing the Li/Na ratio increasing along the length of the evaporator structures, with Li concentrated by >675 times at the top when using seawater (7A) and >39 times at the top when using brine (7B).

FIG. 7C is a graph showing the Li/Na ratio is >200 times higher than that in the Na-rich salt shell, indicating the spatial separation of Li and Na in the radial direction.

FIG. 7D is a graph showing a comparison of the average water evaporation rate (E.R.) at the SQM Li production site in Salar de Atacama, Chile, and the average evaporation rates of a 24-fiber-crystallizers array in the dark, under 1 sun irradiation, and under 0.5 m/s wind.

FIG. 8A is a schematic illustration of the geometry and parameters considered in the theoretical model.

FIGS. 8B and 8C are graphs showing predictions of the Li ion concentration (8B) and Li/Na ratio (8C) as a function of the position inside the crystallizer.

FIG. 9 is a graph showing evaporation rates of the untwisted string (24±1.2 kg/(m²·h)), 1 twisted string (108±15.2 kg/(m²·h)), and 4 twisted strings (225±29.7 kg/(m²·h)).

FIG. 10 is a schematic illustration of a wash-soak cycle to regenerate an evaporator structure.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Inspired by natural plant transpiration, modularized (3D) engineered evaporators is disclosed, which may be made of natural materials, and has been designed and tested for continuous (or substantially continuous) usage. These evaporators may be used for, e.g., water vapor generation to provide affordable and clean drinking water. The engineered evaporators can be made of wood materials, fabrics, or other natural materials and may, e.g., take advantage of the water convection capability of the hierarchical wood xylems or fiber structures and lifted water off the ground by capillary action and cohesion-tension pulling. The extensive surface area evaporated water at a temperature cooler than the surrounding air, drawing on multiple environmental energy sources including solar, wind, or ambient heat in the air and realized continuous operation.

Since evaporation is less susceptible to excessive salinity in water compared with membrane-based separation, the disclosed approach can also be used for zero-liquid discharge and recovery of the valuable minerals in the precipitate.

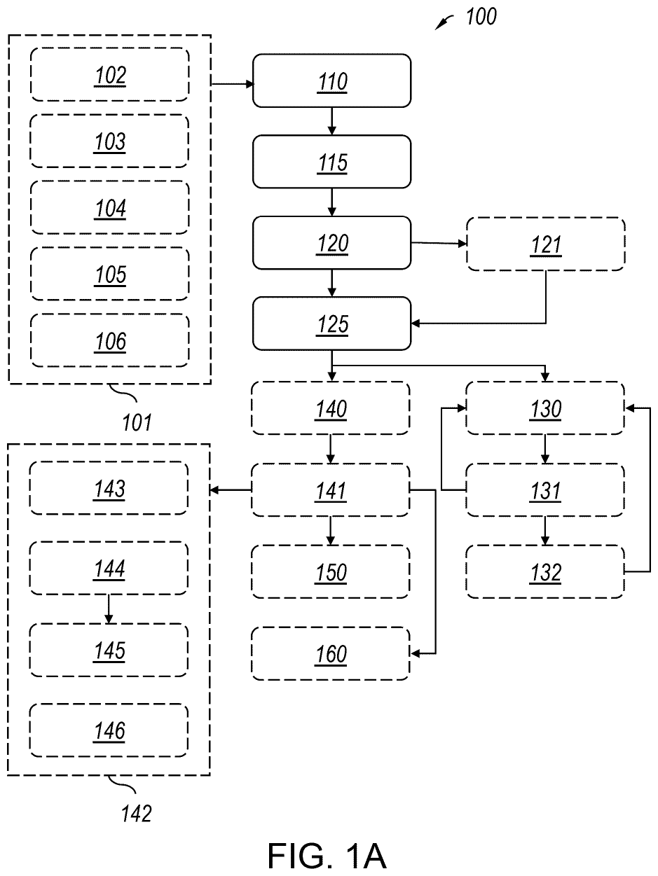

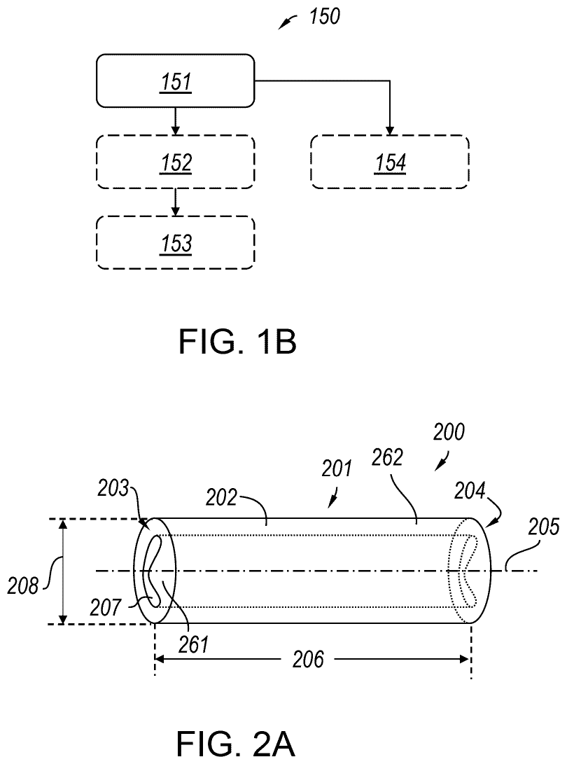

In some embodiments, a process for water, organics, and/or mineral recovery may be provided. Referring to FIG. 1A, the process 100 may include providing 110 a plurality of evaporator structures. The process may include contacting 115 the first end of each evaporator structure with a liquid.

### Evaporator Structures

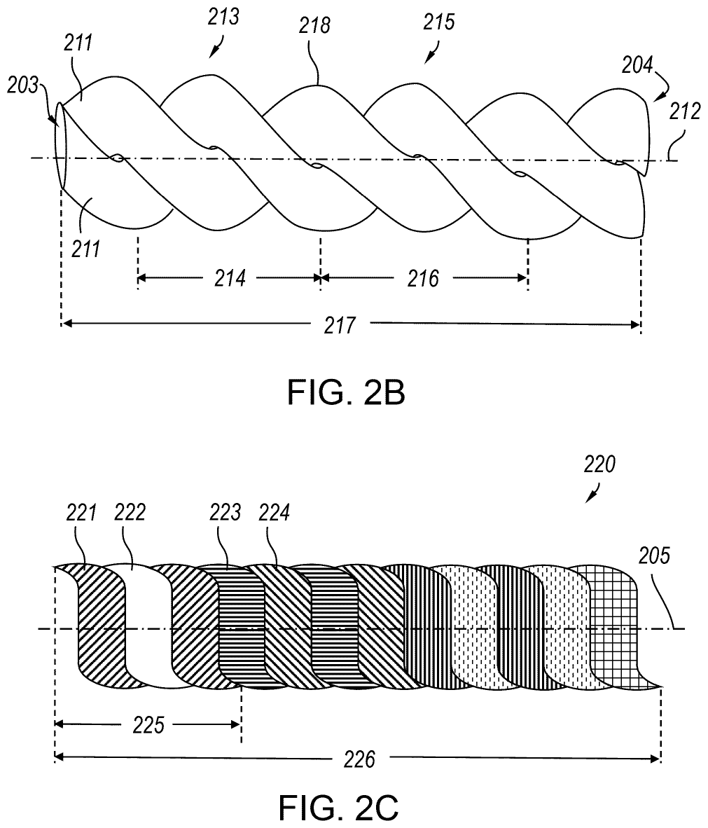

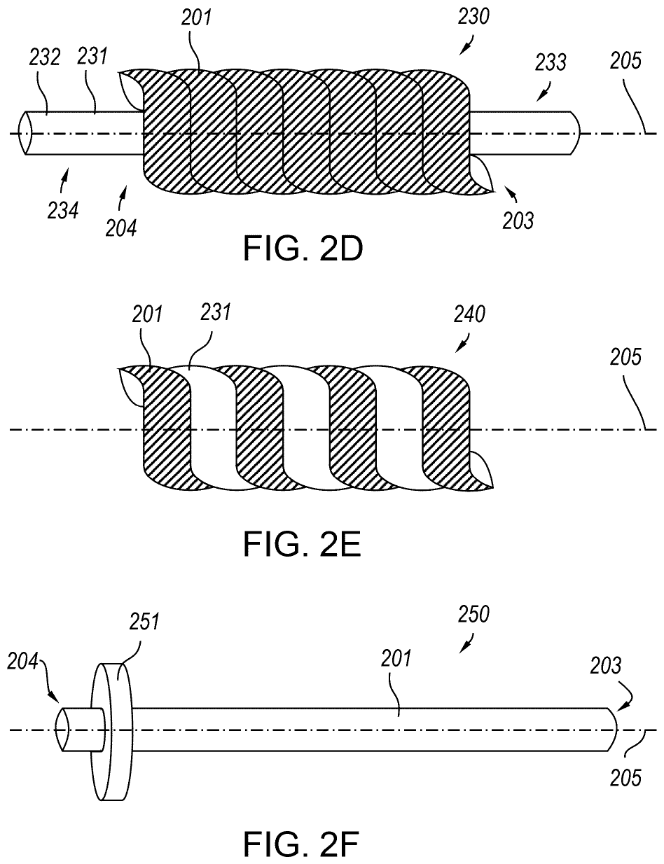

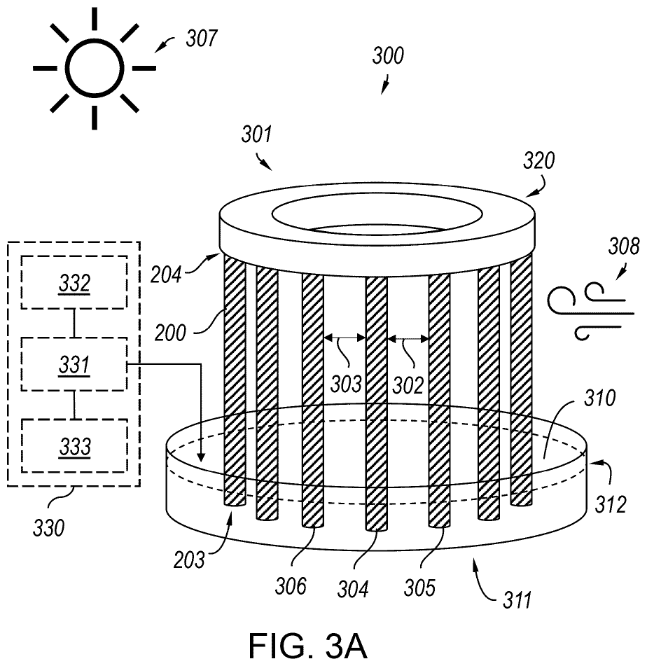

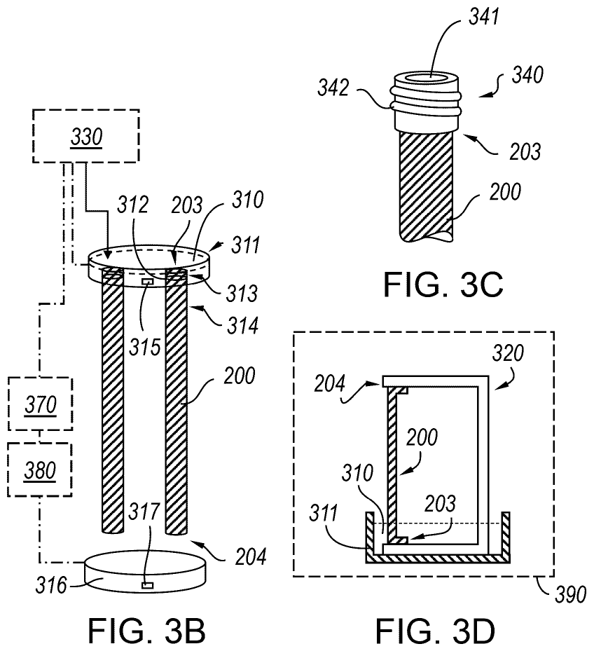

The evaporator structures may be understood with reference to FIGS. 2A-2F, and 3A-3D.

Referring to FIG. 2A, each evaporator structure 200 may include at least one elongate member 201. In some embodiments, the elongate member may be a flexible elongate member. Each elongate member may comprise or consist of a porous material 202.

In some embodiments, the porous material may include a plant-based material, a polymer, a ceramic, porous carbons, geopolymers, hydrogels, textiles, or a combination thereof. In some embodiments, the porous material may include natural wood materials, synthetic polymers, ceramics, porous carbons, geopolymers, or a combination thereof. In some embodiments, the porous material may be a wood material. In some embodiments, the porous material may be a plant-based fabric. The term “fabric” as used herein refers to woven, woven or non-woven materials. Knitted fabrics may be weft knit, circular knit, warp knit, narrow elastic and lace. The woven fabric may be any fabric, such as satin weave, twill weave, plain weave, oxford weave, basket weave and narrow elastic. The non-woven material may be meltblown, spunbonded, wetlaid, staple fibers based on ground fibers, and the like. In some embodiments, the porous material may be an unmodified plant-based material, such as cotton or cellulose. The term “unmodified” indicates the plant-based material has not been genetically or chemically modified from how it exists in nature. For example, a surface-treatment that chemically modified the surface will render the plant-based material “modified”, while simply adding an additional coating layer around the porous material would leave the porous material as “unmodified”. In some embodiments, the porous material may be a modified plant-based material. In some embodiments, the modified plant-based material may be a chemically-modified plant-based material.

The porous material may define a structure that has a first end 203 and a second end 204 opposite the first end, the first end and the second end separated along an axis 205 by an axial length 206. In some embodiments, each evaporator structure has an axial length of at least 0.1 meters. In some embodiments, each evaporator structure has an axial length of at least 0.5 meters. Advantageously, in some embodiments, each evaporator structure has an axial length of at least 1 meter. In some embodiments, each evaporator structure has an axial length of at least 1.5 meters. In some embodiments, each evaporator structure has an axial length of at least 10 meters. In some embodiments, each evaporator structure has an axial length of at least 5 meters. In some embodiments, each evaporator structure has an axial length of at least 3 meters.

In some embodiments, each evaporator structure has a maximum outer diameter of 50 mm. In some embodiments, each evaporator structure has a maximum outer diameter of 25 mm. In some embodiments, each evaporator structure has a maximum outer diameter of 10 mm. In some embodiments, each evaporator structure has a minimum outer diameter of 1 mm. In some embodiments, each evaporator structure has a minimum outer diameter of 2 mm. In some embodiments, each evaporator structure has a minimum outer diameter of 3 mm. In some embodiments, each evaporator structure has a minimum outer diameter of 5 mm.

Advantageously, in some embodiments, each evaporator structure has a length-to-radius ratio of at least 10:1 and is positioned (or oriented) substantially vertically. In some embodiments, the length-to-cross sectional area ratio is at least 5:1. In some embodiments, the length-to-cross sectional area ratio is at least 10:1. In some embodiments, each evaporator structure has a length-to-radius ratio of at least 100:1 and is positioned (or oriented) substantially vertically. In some embodiments, each evaporator structure has a length-to-radius ratio of at least 500:1 and is positioned (or oriented) substantially vertically.

The porous material may have pores in both the axial and radial direction, allowing material to be transported axially and radially. In some embodiments, the porous material may have one or more lumens 207 extending from the first end to the second end. In some embodiments, the lumens may be substantially circular in cross-section. In some embodiments, the lumens may be irregular in cross-section.

Advantageously, in some embodiments, each evaporator structure 200 may have an inner pore structure 261 that is hydrophilic, and an outer surface 262 that is hydrophobic. In some embodiments, each evaporator structure may have an inner pore structure 261 that is lipophilic, and an outer surface 262 that is lipophobic. Advantageously, in some embodiments, each elongate member 201 may have an inner pore structure that is hydrophilic, and an outer surface that is hydrophobic. In some embodiments, each elongate member may have an inner pore structure that is lipophilic, and an outer surface that is lipophobic.

The porous material preferably has a porosity (i.e., volumetric fraction of pores in the material) greater than 50%.

In some embodiments, each structure may consist of a single elongate member, as seen in FIG. 2A. Referring to FIG. 2B, in other embodiments, each structure 210 may include a plurality of elongate members 211 coupled together. As seen in FIG. 2B, the elongate members (sometimes referred to as “fibers”) are twisted around each other, such as along an axis 212, to form a spiral pattern having a first pitch 214.

For elongate members with the same axial length, an elongate member being so twisted will have a shorter distance 217 between the first end 203 and second end 204 as compared to an elongate member that has not been so twisted.

In some embodiments, one or more elongate members are formed from a single “fiber” extending from the first end to the second end. In FIG. 2C, it can be seen that in other embodiments, one or more elongate members 220 may be composed of multiple short fibers (e.g., fibers 221, 222, 223, and 224) interlocked together, where each short fiber (e.g., fiber 221) has a total length in the axial direction (i.e., in relation to central axis 205) that is shorter than the total length 226 of the elongate member 220 in the axial direction.

In some embodiments, if the elongate members are flexible, it may be advantageous to incorporate a rigid member into the evaporator structure, where the rigid member is operably coupled to the flexible elongate member. This may be done in various ways.

Referring to FIG. 2D, in some embodiments, a evaporator structure 230 may include a rigid elongate member 231 extending along a central axis, and a flexible elongate member (such as an embodiment of elongate member 201) may be disposed on an outer surface 232 of the rigid elongate member. In some embodiments, a portion 233 of the rigid elongate member may extend axially beyond the first end of the flexible elongate member. In some embodiments, a portion 234 of the rigid elongate member may extend axially beyond the second end of the flexible elongate member. The rigid elongate member should have a stiffness greater than that of each flexible elongate member.

Referring to FIG. 2E, in some embodiments, a evaporator structure 240 may include a rigid elongate member 231 twisted and intertwined with one or more flexible elongate members, forming a similar structure to that shown in FIG. 2B. In FIG. 2E, just a single elongate member, such as elongate member 201, is shown, but those skilled in the art will understand that additional elongate members could readily be incorporated.

In some embodiments, a weight may be operably coupled to an end of the evaporator structure. As seen in FIG. 2F, a evaporator structure 250 may include one or more elongate members (here, only elongate member 201 is shown), where a weight 251 is operably coupled to the second end of the elongate member. In some embodiments, the weight may be attached to a flexible elongate member. In some embodiments, the weight may be attached to a rigid elongate member. In some embodiments, a weighted member may be operably coupled to either the first end or the second end of a evaporator structure.

Referring to FIG. 3A, a system may be seen that incorporates multiple evaporator structures. As shown, a system 300 may include an apparatus 301 that includes a plurality of evaporator structures 200 as disclosed herein.

Each evaporator structure is physically separated from an adjacent evaporator structure. Here, a first evaporator structure 304 is separated from a second evaporator structure 305 by a first distance 302, and the first evaporator structure is separated from a third evaporator structure 306 by a second distance 303. In some embodiments, the distances separating one evaporator structure from adjacent evaporator structure(s) is identical (e.g., first distance 302=second distance 303). In some embodiments, at least one distance separating a evaporator structure from an adjacent evaporator structure is different from at least one other such distance (e.g., first distance 302≠second distance 303).

In some embodiments, the plurality of evaporator structures may be arranged in an array. In some embodiments, placement of the evaporator structures relative to each other may be based on geographic or environmental conditions. For example, in some embodiments, if the liquid is flowing from a first location to a second location, the evaporator structure(s) may be placed based on the flow pattern of the liquid.

As disclosed herein, each evaporator structure has a porous structure. The porous structures are configured to use capillary forces or siphonic action to draw a liquid from the first end towards the second end.

The evaporator structures may be formed to have various geometries. In some embodiments, each evaporator structure may have a substantially identical geometry. Typically, a “substantially identical geometry” may be one where the physical dimensions (including lengths, angles, etc.) do not vary by more than 10%. In some embodiments, at least one of the plurality of evaporator structures may have a different geometry. In some embodiments, each evaporator structure may define a geometry that is substantially cylindrical, spiral, pyramidal, conical, prism, or rectangular.

In some embodiments, each evaporator structure has an identical composition. In some embodiments, each evaporator structure is composted of natural wood materials, twisted fibers from natural materials, fibers from synthetic material, or a combination thereof. In some embodiments, only natural materials are utilized. In some embodiments, only synthetic materials are used. In some embodiments, at least one of the plurality of evaporator structures defines a spiral geometry. In some embodiments, the elongate member(s) of at least one of the plurality of evaporator structures may comprise or consist of natural cotton or plant fiber. In some embodiments, at least one of the plurality of evaporator structures may include a bundle of plant fibers spun into a yarn with a diameter of 1 mm, and 4 yarns are further twisted into 1 cord with a diameter of 2 mm.

In some embodiments, the evaporator structures are coupled to a frame. In some embodiments, a frame 320 may be operably coupled to only a second end. As seen in FIG. 3D, in some embodiments, a frame may be coupled to a first end and a second end. As will be understood, the evaporator structures include a rigid member, the frame may also be coupled to only a first end.

The frame may be configured to position each evaporator structure in a vertical or substantially vertical position. “Substantially vertical” typically means that if an imaginary line were drawn between the first end and the second end, the line would be within 10 degrees of a vertical line. In some embodiments, this may include where over 60%, 70%, 80%, or 90% of the evaporator structure is vertical or within 10 degrees of vertical.

The frame may have any appropriate configuration. In some embodiments, the frame may have a cross-section defined by an annulus. In some embodiments, the frame may be composed of an IR-transparent material. In some embodiments, the frame may be composed of a non-conductive material.

The frame may be configured to position the first end of each of the plurality of evaporator structures to within a liquid 310. For example, in some embodiments, the first end may be positioned below a top surface 312 of a liquid 310.

In some embodiments, a container 311 for the liquid 310 may form, or be a part of, a frame. The container may be open on one side or may be a closed vessel. The closed vessel may have a lid that opens and closes as needed or may have one or more ports to add or remove materials as needed. In some embodiments, the container may include one or more sensors 315. Such sensors may include level detectors or may be configured to detect concentrations of a particular material within the liquid.

In some embodiments, the evaporator structures may be coupled to the container. In some embodiments, the evaporator structures may be configured to draw liquid upwards away from the container. Referring to FIG. 3B, in some embodiments, the evaporator structures may be configured to draw liquid downwards away from the container. In FIG. 3B, a portion of the evaporator structure may be positioned within the container and may be positioned such that the first end is positioned within the liquid. In some embodiments, the evaporator structures may pass through an opening 312 in the container 311. The opening may extend through a wall of the container to allow the liquid to pass from the container into or through the elongate members that form the evaporator structures. For example, in some embodiments, the liquid enters the first end of a evaporator structure which is in a first portion 313 that is with the container, then passes through the opening to a second portion 314 that is below the opening, outside of the container, towards the second end.

As seen in FIG. 3C, in some embodiments, a evaporator structure may be coupled to a connector 340. In some embodiments, the connector may be coupled to a first end of the evaporator structure. In some embodiments, the connector may be coupled to an outer surface of the evaporator structure. In some embodiments, the connector may be coupled to an outer surface of the evaporator structure at a location other than the first end.

The connector may include a lumen 341 extending therethrough. In some embodiments, the lumen may be configured to receive liquid and allow it to reach the evaporator structure.

The connector may include one or more extrusions or depressions on an outer or inner surface of the connector. For example, as shown in FIG. 3C, in some embodiments, the connector may include threads 342 on an outer surface of the connector. The connector is advantageously configured to be removably connected to a frame. In some embodiments, the connector may be removable connector to a container.

It will be understood that the connector may appear on one or both ends of a evaporator structure. In some embodiments, a second end of a first evaporator structure may be connected to a first end of a second evaporator structure using connectors. In some embodiments, a single connector is coupled to both structure(s). In some embodiments, a first connector is coupled to the first structure, and a second connector is coupled to the second structure, where the two connectors are configured to be removably coupled together. Such an approach may be useful for, e.g., applications where it may be necessary to remove/replace a single portion of the overall combined structure separately from another portion of the combined structure. When used in this manner, it will be understood that the serially-connected structures may be identical, or may be different. For example, in one embodiment, the pore structure in a first evaporator structure may be different from the pore structure in the second evaporator structure connected to it, or may be composed of a different porous material.

Referring to FIG. 3D, in some embodiments, the frame may be attached, and advantageously may be removably attached, to a container, and the evaporator structure may be coupled at both ends to the frame, such that the first end is below the surface of the liquid. In some embodiments, the coupling may include adhesion of each end to the frame. In some embodiments, both ends may be removably coupled to the frame (e.g., using connectors such as those seen in FIG. 3C).

### Liquids

Advantageously, the liquid may include a plurality of materials. The plurality of materials may include a solvent and at least one target material at a first concentration. In some embodiments, the solvent may advantageously be water. When the liquid is aqueous, the internal pore structure of each evaporator structure is preferably hydrophilic. In some embodiments, the solvent may be an oil, such as a hydrocarbon. When the liquid is oil-based, the internal pore structure of each evaporator structure is preferably lipophilic.

In some embodiments, the liquid may include seawater, brine lake and reservoir water, groundwater, geothermal brine, wastewater, or other saline water sources. In some embodiments, the at least one of the plurality of materials includes a volatile organic material or a mineral.

In some embodiments, the liquid (which may be water) may be collected in the form of vapor or liquid. In some embodiments, the liquid is collected only in the form of a vapor. In some embodiment, the liquid is collected only in the form of a liquid.

In some embodiments, the liquid may include a metal or a metalloid. In some embodiments, the liquid may include In some embodiments, the liquid may include lithium, silver, gold, nickel, cobalt, copper, aluminum, iron, zinc, molybdenum, boron, potassium, sodium, calcium, magnesium, manganese, selenium, platinum, uranium, silica, a rare earth element, or a combination thereof.

In some embodiments, the liquid may include an organic solvent, a volatile fatty acid, or a combination thereof.

In some embodiments, the liquid may include a plurality of salts. In some embodiments, the plurality of salts may include a first salt comprising a targeted mineral, and a second salt. In some embodiments, the targeted mineral may be lithium. In some embodiments, the targeted mineral may be an alkali metal, an alkaline earth metal, a transition metal, a post-transition metal, a lanthanoid, an actinoid, or a combination thereof.

Referring to FIG. 1A, in some embodiments, the process may include adjusting 106 a pore size of at least a portion of a evaporator structure. In some embodiments, the pore size may be modified by, e.g., chemical treatment (particularly for plant-based materials). Such chemical treatments are known in the art. In some embodiments, the pore size may be modified by twisting. In some embodiments, pores allowing transport from the first end to the second end may have a pore size of, e.g., 20 to 60 μm. By increasing the twist (reducing the pitch of the spiral formed by the twist), those pores are compressed, reducing the average pore size. Referring to FIG. 2B, in some embodiments, the pore size may be modified by rotating a first portion of the evaporator structure (such as the first ends of the elongate members) around a central axis 212 relative to a second portion of the evaporator structure (such as the second ends of the elongate members)—that is, by twisting the members together—the rotation/twisting will cause the first pitch to be changed to a second pitch different from the first pitch. If the first ends and second ends are used when rotating the members, the pitch will be generally uniform along the length of the evaporator structure. However, an intermediate point 218 is used, other variations can be formed. For example, in some embodiments, a pitch 214 of the elongate members in a first portion 213 of the evaporator structure (formed by, e.g., holding the first ends and the intermediate point and rotating them relative to each other) may be different from a pitch 216 of the elongate members in a second portion 215 (formed by, e.g., holding the second ends and the intermediate point and rotating them relative to each other).

Referring to FIG. 1A, the process may include allowing 120 capillary forces or siphonic action to draw at least one material of the plurality of materials from the first end towards the second end. Those capillary forces of siphonic action are useful, because they allow different materials in the liquid to travel different distances through the evaporator structures, based on various factors. By controlling or tuning one or more of such factors as disclosed herein (e.g., hydrophilicity, pore size), by selecting appropriate dimensions for the evaporator structure (e.g., with particular diameter and length), a user can predict or control what materials, if any, exit the second end of the evaporator structure, and what the profile of the materials in the liquid will be along the length of the evaporator structure.

In some embodiments, the process may include applying 121 an electrical or magnetic field to the evaporator structure(s). The field may be used to, e.g., apply a force to one or more ionic materials in the liquid as the liquid flows through the evaporator structure(s). In some embodiments, the field may be used to slow transport of a material in the axial direction. In some embodiments, the field may be used to accelerate transport of a material in the axial direction. This may be started and stopped at any time in the process, any may be cyclical in application (for example, 10 minutes on, 10 minutes off, repeating). In some embodiments, the electric field is applied while some or all of the liquid is being transported through the evaporator structure(s). In some embodiments, the electric field may be applied by, e.g., an electric field generator 370 (see FIG. 3B), which may include, e.g., an electric coil. In some embodiments, the magnetic field may be applied by, e.g., a permanent magnet or an electromagnet.

The process may include crystallizing the plurality of salts in or on the porous crystallizer, where salts with lower solubility are crystallized within a first distance from the first end, while salts with a higher solubility are crystallized after the first distance and before a second distance from the first end, or pass through the evaporator without crystallization, such that different salts precipitate sequentially (which, for ease of understanding, can be analogized to chromatographic separation) on the crystallizer structure with both radial and axial structures, or at least one salt will be collected in a dissolved form in the solvent passing through the second end of the structure.

The process may include evaporating 125 one or more of the plurality of materials by transferring at least one form of environmental energy directly to each evaporator structure, thereby providing the latent heat of vaporization. In some embodiments, the plurality of forms of environmental energy may include at least one of solar energy (see, e.g., sun 307 in FIG. 3A), wind energy (see, e.g., wind 308 in FIG. 3A), and ambient heat of air. In some embodiments, the evaporating may include causing air to pass around and/or through each evaporator structure. In some embodiments, the evaporating may include allowing a light source to irradiate the evaporator structure.

In some embodiments, the evaporation may occur under ambient temperature conditions. In some embodiments, the evaporation may occur at temperatures above 30° C. In some embodiments, the evaporation may occur at temperatures above 50° C.

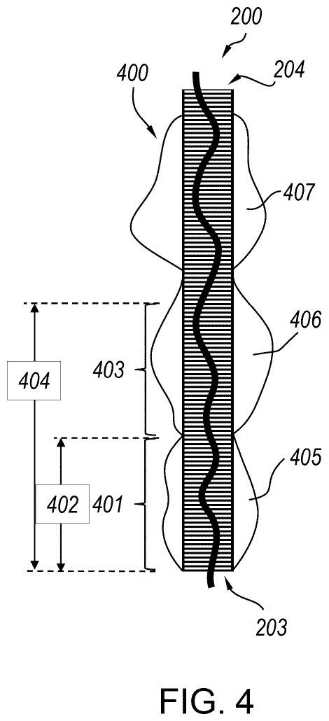

In some embodiments, evaporating one or more of the plurality of materials may include allowing a salt shell 400 to form around the evaporator structure 200 (see FIG. 4).

Referring to FIG. 1A, in some embodiments, the process may include collecting 130 the at least one target material after the at least one target material passes from the first end to the second end. In some embodiments, this may include using a collection reservoir 316 (see FIG. 3B). In some embodiments, the process may include determining 131 a concentration of the at least one target material being collected. This may be done using, e.g., a sensor 317 (see FIG. 3B).

In some embodiments, the process may include causing 132 an adjustment to the process. Such adjustments may include a chemical modification to the liquid, or a physical adjustment to the evaporator structure(s) and/or a collection reservoir.

For example, the adjustment may include modifying a distance from the second end to a collection reservoir based on the determined concentration. In some embodiments, this may include reducing the distance between the second end and the collection reservoir if the concentration of a target material is too low.

In some embodiments, the adjustment may include modifying the pH of the liquid. In some embodiments, the adjustment may include adding a buffer to the liquid.

In some embodiments, the process may include allowing 140 the capillary forces or siphonic action to spatially separate salts in the liquid by their differences in solubility, hydrophilicity, mobility, charges, polarity, and local concentration.

In some embodiments, the process may include evaporating water and crystallizing the plurality of salts in or on the porous crystallizer, where salts with different solubilities are separated spatially (similar as a chromatographic separation), where high solubility salts move further in distance from the first end.

In some embodiments, the process may include evaporating water and transporting the plurality of salts in or on the porous crystallizer, where salts with lower solubility move relatively slowly from the first end, while salts with a higher solubility move relatively faster from the first end. When not crystallized on the porous crystallizer, the salts with different solubility, mobility, or charges may pass through the porous crystallizer and collected as solute at the end of the crystallizer structure.

In some embodiments, the process may include collecting a first salt that has higher solubility and mobility first as solute after passing through the crystallizer structure, while collecting the second salt with lower solubility and mobility later as solute after passing through the crystallizer structure. In some embodiments, the first salt may be collected in a first container, while the second salt may be collected in a second container.

In some embodiments, the process may include evaporating water and crystallizing 141 the plurality of salts in or on the evaporator structure(s) (see FIG. 4) where salts 405 with lower solubility are predominantly crystallized within a first region 401 that is within a first distance 402 from the first end, while salts 406 with a higher solubility are predominantly crystallized within a second region 403 that is located after the first distance and before a second distance 404 from the first end, the second distance being greater than the first distance from the first end, such that different salts precipitate sequentially on the evaporator structure with both radial and axial structures. This will generally form regions of the crystallized salt structure (e.g., second region 403) where a particular mineral is more concentrated than within other regions (e.g., first region 401).

In some embodiments, the process may include processing 142 salt that crystallizes in or on the evaporator structure(s). For example, in some embodiments, the process may include collecting 143 a first salt (e.g., salt 407) that crystallizes at or near the second end, and separately collecting a second salt (e.g., salt 405) that crystalizes at or near the first end. Note that “at or near” is intended to refer to whatever salts form closest to a described end. For example, in some embodiments, the first salt may be 0.01 m-0.2 m away from the second end, but may be the closest salt to the first end.

In some embodiments, the process may include separating 144 at least a portion of a salt shell at or near the second end from a remainder of a salt shell formed around the evaporator structure. In some embodiments, this may include hitting a portion of the salt shell with a hammer or other blunt instrument. In some embodiments, this may include chiseling the salt away. In some embodiments, this may include using a person's hand to break off the salt shell. In some embodiments, after the first portion is removed, the process may also include removing 145 the remainder of the shell from the evaporator structure.

In some embodiments, the process may include preparing 101 the evaporator structure(s) before being exposed to the liquid. In some embodiments, this may include modifying the surface of the evaporator structure(s). For example, in some embodiments, each evaporator structure has a surface modification configured to reduce the effect of foulants or scalants. Many such surface modifications are known in the art, which may be appropriately selected based on the desired application.

In some embodiments, especially embodiments using plant-based porous materials, such as wood-based materials, the hydrophobic lignin may provide mechanical support to the cell walls, but it may also reduce the wettability of the water channels, raising the risk of cavitation and the formation of air bubbles from the breakage of the water column. To enhance wettability and prevent air cavitation under a high evaporation rate, one can partially remove the lignin using a hydroxide treatment. For example, the contact angle after partial delignification decreased from 51° to 32° (contact angle measured using the captive method), resulting in an increase of the solid-liquid adhesion energy by a factor of 1.5 according to the Young-Dupre equation.

In some embodiments, this may include pretreating 102 the porous material with an alkaline solution, such as an alkaline solution at a concentration of 0.5-2.5 M. In some embodiments, this may include heating 103 the porous material to 70-200 degrees Celsius for 1-10 hours to partially remove one or more impurities. In some embodiments, this may include freeze-drying 104 the porous material for 12-48 hours.

In some embodiments, this may include surface carbonizing 105 the porous material. In some embodiments, this may be done by pressing and rolling the porous material on a hot plate until an external surface of the porous material is uniformly or partially carbonized.

Surface carbonization may be conducted to incorporate the transpiration function of tree leaves into the surface of the wood. Vascular trees including aspen have pitted xylem vessels and medullary rays that allow lateral conductance of water. However, the number of pits and rays often limits fast vapor generation. Surface carbonization was found to create a skin layer with significantly increased porosity as revealed by scanning electron microscopy (SEM). The formation of such a skin layer is due to the thermal decomposition of the outmost cellulose wall. Mercury intrusion porosimetry tests of some example evaporators revealed that the wood surface has a more unified pore size distribution with an average pore throat size of 8±1.2 μm after carbonization. The increased porosity provides a higher effective surface area for evaporation and the shrunken pore throat size enhances water conductance through capillary action. Moreover, C—C bonds were created during the carbonization process. Conjugated C—C bonds are known to absorb visible light, and thus improve the photothermal conversion on the wood surface.

In some embodiments, the process may include processing 150 the evaporator structure(s), to remove, replace, and/or recycle the evaporator structure(s) that are actively being used. For example, referring to FIG. 1B, in some embodiments, the process may include removing 151 at least one of the evaporator structures from the liquid. In some embodiments, two or more evaporator structures are coupled together (e.g., via a frame at one or both ends etc.). In some embodiments, the removal step may include simultaneously removing two or more of the plurality of evaporator structures from the liquid. In some embodiments, this may include removing the evaporator structure(s) from where the evaporator structure(s) may be attached to the frame or container (e.g., by decoupling the connector from the liquid container).

In some embodiments, the process may include washing 152 each evaporator structure that has been removed. In some embodiments, the process may include re-coupling 153 the first end of each evaporator structure to the liquid. In some embodiments, the process may include placing 154 the first end of a new evaporator structure into the liquid after the at least one of the evaporator structures has been removed from the liquid.

In some embodiments, the process may include capturing and condensing 160 water from liquid that has exited the second end of the evaporator structure(s).

In some embodiments, a system may be provided. Referring to FIG. 3A, in some embodiments, the system 300 may include an apparatus 301 as disclosed herein, and a liquid 310, where the first end of each evaporator structure is operably coupled to the liquid (for example, positioned within the liquid). In some embodiments, the system may include a container 311 configured to hold the liquid.

In some embodiments, the system may one or more additional components 330. In some embodiments, the one or more additional components may include a pump 331 configured to pump the liquid from a liquid source 332 to the container.

In some embodiments, the system may include at least one processor 333 operably coupled to the pump, and configured to control the pump. As will be understood by those of skill in the art, the processor(s) may be coupled to a memory and a non-transitory computer-readable storage medium (not shown), where the non-transitory computer-readable storage medium may contain instructions that, when executed by the processor(s), configures the processor(s) to perform certain steps of the process. In some embodiments, the processor(s) may be coupled to one or more sensor(s) (such as sensor 315 and sensor 317 in FIG. 3B).

In some embodiments, the system may include a housing 390 configured to surround at least a portion of the apparatus.

In some embodiments, the system may include a collection container 316. The collection container may be configured to collect at least one target material present in the liquid after the at least one target material passes from the first end to the second end of at least one evaporator structure.

In some embodiments, the system may include a fan 380 configured to direct air across at least a portion of each evaporator structure. The fan may be coupled to the housing. In some embodiments, the fan may be operably coupled to the processor(s), and the processor(s) may be configured to control the fans. In some embodiments, the processor(s) may control the fans based on information from a sensor, such as sensor 317 in a collection container.

In some embodiments, the system may include an electric field generator 370 configured to expose each evaporator structure to an electric field. In some embodiments, the electric field generator may be operably coupled to the processor(s), and the processor(s) may be configured to control the electric field generator. In some embodiments, the processor(s) may control the electric field generator based on information from a sensor, such as sensor 317 in a collection container.

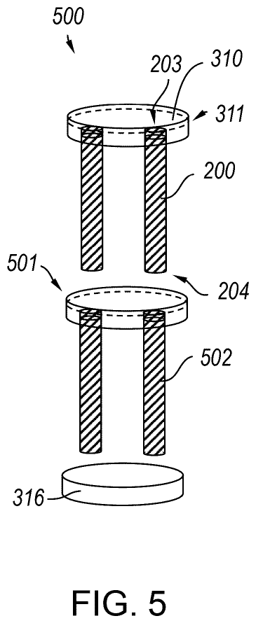

In the figures, it the evaporator structures have been shown to be used in parallel. However, the evaporator structures may also be used serially. As seen in FIG. 5, in one embodiment, the system 500, a first evaporator structure 200 may be coupled to a first liquid 310, where the liquid output from that first structure is captured in a second container 501. A second evaporator structure 502 is coupled to the liquid output from the first structure. As will be understood, this may be repeated with additional structures as desired. In some embodiments, the two structures may be identical. In some embodiments, the two structures may be different.

The water-lifting height, water evaporation rate and the mineral precipitation of these devices and systems can be controlled by, e.g., tuning the properties of the evaporator(s) such as pore size, porosity, aspect ratio, surface energy, as well as adjust operation conditions such as solar irradiation strength, wind speed, temperature and relative humidity.

Compared with the other desalination systems that have membrane-based desalination units, the disclosed device requires the lowest capital investment, the simplest system design and a minimum operation or maintenance cost. Although drought-stricken regions without safe or stable water sources are prime candidates for the disclosed device, small communities and commercial buildings in the developed world could also benefit from their use, and they make a great fit for off-grid homes and emergency preparedness.

Meanwhile, valuable minerals in the precipitate can be recovered. Compared with the state-of-the-art mineral recovery processes (solar evaporation pond), the disclosed approach largely shortens the time span of each recovery cycle, reduces the land use, and increases the yield of the minerals.

The disclosed 3D evaporators possess a much higher surface area for evaporation and much lower thermal energy loss compared with the conventional solar still (for water purification) and solar evaporation pond (for volume reduction and mineral recovery). Compared with other industrialized water or mineral production technologies such as reverse osmosis, multi-effect distillation, multistage flash distillation, mechanical vapor compression that require significant capital investment, energy/chemical consumption during operation, the disclosed approach utilizes the freely available environmental energy with insignificant initial investment and operational cost.

The spatially separated precipitation of minerals enabled by the specific design of the 3D evaporators represent a process to selectively extract and recover valuable metals without selective membranes, adsorbents, resins, which are required in other technologies and can be costly and carbon heavy.

### Example 1

In one example, a natural wood derived 3D evaporator device was formed, using 16 aspen round dowels each with a diameter of 0.8 cm and a length of 0.5 m as the exemplary raw material for the disclosed approach. The aspen dowels were soaked in an alkaline solution with 1.5 M NaOH and 0.3 M Na₂SO₃ and heated to 80° C. for 5 hours to partially remove the lignin. The treated aspen dowels were then freeze-dried for 24 hours after excessive rinsing with deionized water. Surface carbonization was done by pressing and rolling the dried aspen dowel on a 500° C. hot plate until the wood surface was uniformly carbonized. The carbonized evaporators were then soaked in deionized water to release the carbon debris for another 24 hours.

The individual evaporators were assembled into a square 4×4 array by fixing them onto pre-templated styrofoam frame with a controlled spacing of 0.5 cm between each of the evaporators. The styrofoam provided thermal insulation, light reflection and buoyancy which allowed the evaporators to float on the water whilst having 5 cm of their lower section submerged in seawater. The device and liquid were placed in an enclosed transparent plastic chamber, in the sun, with a solar-powered fan installed on a sidewall to provide 1 m/s air flow through the chamber.

The water-wicking capability and vapor generation rate of a single such 3D evaporator was evaluated under one-sun irradiation and in dark conditions. Synthetic seawater comprising 3.5 wt % NaCl solution was used as the feed water.

Natural wood shows relatively poor water-wicking properties due to the presence of hydrophobic lignin in the wood xylems. When unmodified natural wood is used for the 3D evaporator, during the evaporation test, the natural wood also showed a gradually decreasing evaporation rate, indicating water-wicking becomes the bottleneck for vapor generation. As seen in thermal images, partial delignification allows the complete wetting of the engineered tree and the surface carbonization had a minor effect on the water conduction since the skin layer was only ˜10 μm. A cross-sectional X-ray image of the engineered tree shows that over 97% of the xylem tracheids near the side-surface, as well as the radial channels (i.e., medullary rays), were saturated with water, which provided a sufficient water supply for vapor generation. In the dark condition, the temperature of the wood surfaces was measured to be 17° C., around 3° C. cooler than the surrounding air since heat was absorbed by water vapor as latent energy. Under one-sun irradiation, the temperature on the top surface of the engineered tree increased and equilibrated at 22.9° C. Due to the low thermal conductivity of the wood material and high evaporation rate at the sidewalls, the increase in surface temperature was only observed within one inch from the top of the wood, whereas the rest of the 3D evaporator underwent water evaporation at a lower temperature similar to that of the dark condition.

Compared to the natural wood, the engineered 3D evaporator exhibits a more than tenfold faster water evaporation rate because of the significantly greater effective surface area available for evaporation. Under one-sun irradiation, the evaporation rate of a single engineered 3D evaporator was measured to be 1.30±0.08 g/hour, which converts to a high water production rate of 26.0±1.6 LMH (liter per square meter of projected area per hour) due to the large LAI (the projected area of leaves over a unit of land for the species of wood). Three energy sources are believed to be the contributors of the latent heat required for vaporization: the specific heat of wood and water, the solar energy, and the ambient heat. The wood only contributed thermal energy during the initial stage of evaporation as its temperature reached steady-state within minutes. It was found that the temperature of the water on the wood surface dropped 3° C. as it was wicked from the feed reservoir. The energy flux associated with this temperature change of water was calculated to be 1.5×10⁻³ W, notably less than the latent heat of vaporization (i.e., 0.9 W). The solar irradiation provided on the top surface of the engineered tree was controlled at 1000 W/m², which converts to 0.05 W considering the size of the top surface (i.e., 0.5 cm²). It was also found that the side surface absorbed a considerable amount of diffusive solar energy (i.e., light reflected by other objects and absorbed by the side surface). Indeed, the evaporation rate decreased to 1.04±0.03 g/hour when a light-reflecting cover was installed, casting a shadow over the side surface of the engineered tree (FIG. S4). Therefore, the energy contribution from the diffusive light was estimated to be 0.2 W based on the evaporation rate difference. Hence, the remaining, and largest, energy contribution (i.e., 0.66 W) is attributed to the ambient heat, which accounts for over 70% of the total energy input. When gradually decreasing the solar irradiation from 1000 W/m² to 500 W/m², the evaporation rate was seen to decrease slightly to 1.05±0.01 g/hour. Assuming both the direct solar radiation and diffusive solar energy decrease linearly with the light source, the energy contribution from the ambient heat was found to be almost constant.

To further verify the energy contribution from the ambient heat, we removed the solar simulator, leaving ambient heat as the only major energy contributor for evaporation. In the dark condition, the total amount of energy for evaporation was found to be 0.57 W, comparable to the previous result (i.e., 0.66 W). Therefore, by keeping a cooler surface to allow passive absorption of ambient heat in the surrounding air, the total energy for evaporation can reach 359% of the one-sun irradiance.

To evaluate the evaporation performance as the system is scaled up, the engineered 3D evaporators were tested in a closed lab environment with a spacing of 0.5 cm between the trees. The average vapor generation from each of the engineered 3D evaporators decreased and reached a plateau of 0.65 g/hour as the total number of trees increased from one to sixteen. The LAI of the overall system also decreased to 55 due to the void spaces between the engineered 3D evaporators.

Analysis of the individual energy contributions in the 4×4 tree lattices revealed that the contribution of ambient heat to the total latent heat of vaporization decreased to ˜65% as a result of reduced temperature gradient within the tree lattice. Nevertheless, the total energy for evaporation can still reach 284% of one-sun irradiance, resulting in a high vapor generation rate of 4.8 LMH. To compare with the other interfacial solar desalination devices, the solar-to-vapor conversion efficiency was calculated. The latent heat associated with the solar induced evaporation (i.e., 3.24 g/hour if the dark control was deducted) was found to be 994 W/m², close to the one sun irradiation provided. Such a high efficiency was mainly due to the cooler-than-ambient surface temperature that minimized the heat loss. Further increasing the number of trees to a more significant number would lead to a LAI of 45 and an overall evaporation rate of ˜4.6 LMH based on data extrapolation.

Analogous to the other desalination techniques, inadequate mass transfer is a major obstacle to achieving high performance. Water vapor generated on the side surfaces is likely to get trapped in the void spaces between the engineered trees, reducing the vapor pressure difference that drives evaporation. However, having oversized gaps between the engineered trees also compromises the overall efficiency due to the reduced LAI. To optimize the evaporation performance, COMSOL Multiphysics was used to simulate the mass transfer within the engineered tree lattice. It was found that the system had the highest LAI when all the engineered 3D evaporators were set in close contact. However, the evaporation rate of such configuration was significantly lower (i.e., 0.26 g/hour) due to the quick saturation of water vapor in-between individual 3D evaporators making up the engineered 3D evaporator lattice. Increasing the distance between the engineered trees enhanced mass transfer until the evaporation rate plateaued at a distance of around 0.8 cm. The water vapor generation from a single 3D evaporator in this case was more than three-time faster than that in the close contact setup and remained almost constant when the gap size was further enlarged. However, as the gap size increased, the LAI decreased exponentially, which offset the benefit of the enhanced mass transfer. It was found that the optimized gap size was 0.5 cm for the simulated system with a unidirectional airflow rate of 0.1 m/s.

The limitations of energy and mass transfer can be reduced by increasing airflow through the system without sacrificing the LAI. The thickness of the thermal boundary layer (i.e., a thin region where the temperature varies as a function of distance from the surface to the atmosphere) is reduced by increasing fluid velocity, resulting in reduced conductive heat transfer resistance. Similarly, the air velocity across the surface will affect the convective mass transfer and vapor diffusion in the boundary layer. Experimental measurements showed that the evaporation rate increased notably to 12.9 LMH when 1.6 m/s airflow was provided by a spinning fan. A drop in air temperature of ˜1.5° C. and increase in relative humidity (RH) of 33% was detected across the engineered 3D evaporator lattice when the airflow was present, indicating enhanced energy and mass transfer. The COMSOL simulation also indicated that the airflow can effectively reduce the boundary layer thickness and enhance both the mass and energy transfer. Evaporation enhancement has been realized in wind-aided intensified evaporation (WAIV). The tall and thin cylindrical geometry of the example 3D evaporators not only have a higher surface area, but also lead to a more efficient mass and energy transfer than the flat-sheet sails used in WAIV. Eddies or vortices could form in the flow patterns over a series of cylinders, providing additional mixing.

As salt water vaporizes, salts are left behind on the evaporative surfaces. Salt precipitation has been a major barrier for solar-thermal desalination devices as the crystals block the pores and scatter sunlight, resulting in lower evaporation rate. Strategies to slowdown salt excretion have been proposed including hydrophobic surface modification, fish-schooling-inspired rinsing and cross-flow creation. Although these strategies have been proven effective for the 2D interfacial desalination devices, certain limitations including the increased heat loss and cost of materials exist. Additionally, most of the current solar-thermal desalination devices suffer from accelerated salt precipitation as a side effect of fast vapor generation, similar to the fouling issues in the RO process. To control membrane fouling, the concept of critical flux needs to be introduced, which is defined as the permeate flux under which the back transport induced by shear and Brownian diffusion of foulants exceeds convective transport toward the membrane. In solar-thermal desalination systems, a stable and sustainable operation is also governed by the critical flux. Given that engineered 3D evaporators have a low areal evaporation rate, similar to a tree leaf, they are less susceptible to salt accumulation.

To investigate salt precipitation and evaluate the critical flux for operation, the engineered 3D evaporators were tested under continuous and intermittent solar irradiation. The evaporation rate was virtually constant at 4.88 LMH under one-sun irradiation for 24 hours. It can be observed that salt precipitation started from the top surface of the engineered trees and the salt front gradually progressed downward. The top surface was exposed to direct sunlight, similar to many other solar-thermal desalination devices, causing the evaporation rate to be higher than the critical flux. The accumulated salt on the engineered trees was weighted to be 1.53 g after 24 hours, around 17% of the total salt dissolved in the feed water that had vaporized. During intermittent operation, the engineered trees were tested under one-sun irradiation for 12 hours, followed by another 12 hours in the dark condition as a representation of the diurnal cycle. The evaporation rate decreased to 2.87 LMH after turning off the light. Salt precipitation was seen to gradually disappear from the wood structure and was completely absent after the 12-hour operation in the dark condition, indicating that the engineered 3D evaporators were operating below the critical flux in dark conditions.

Since the motion of ions in a drying porous medium is driven by convective fluxes and concentration gradients both induced by evaporation, an approximate model is presented to fundamentally understand the critical flux. The net salt flux at the top surface of the engineered 3D evaporator can be expressed as

$$J = {E}_{Top} {C}_{Feed} - {A}_{Top} \frac{D ( {C}_{Surface} - {C}_{Feed} )}{L} \qquad ( Eq . 6 )$$

where ETop denotes water evaporation at the top surface, which was measured to be ˜6% of the total evaporation with solar irradiation and ˜1% in the dark; A_{Top} is the top surface area, 0.5 cm²; D is the diffusion coefficient, 1.6 10⁻⁹ m²/s; C_{surface} and C_{Feed} are the salt concentration at the top surface and in the feed reservoir, respectively. The first term of Eq. 6 accounts for the convective salt flux and the second term represents diffusive salt flux. By using Eq. 6 one assumes that the surface concentration always approaches the solubility of NaCl in water.

It is evident from Eq. 6 that the net salt flux is closely related to the salinity of the feed water. Therefore, the evaporation rate was also evaluated at different water salinities. Increasing water salinity reduces water evaporation as a result of decreased water activity, and subsequently reduces the vapor pressure difference at the water-vapor interface. Nevertheless, the overall convective salt flux is seen to increase with increasing water salinity. Meanwhile, increasing water salinity reduces the concentration gradient across the engineered 3D evaporators, which slows down the salt back diffusion. The net salt flux is negative when water salinity is below 1 wt %, indicating that salt is unlikely to accumulate when the feed water is relatively dilute. As the salinity increases, the net salt flux under one-sun irradiation becomes positive, which is consistent with experimental observation. In the dark condition, the net salt flux is negative for salinity below 11 wt %, suggesting salt could passively dissolve back during the night time. To quantify the passive salt dissolution in the engineered 3D evaporator lattice, the concentration of the feed solution (started at 3.5 wt %) was monitored by measuring the conductivity. Salt accumulation increased when the system operated under one-sun irradiation and reached a maximum of 1.39 g after 12 hours. In the dark condition, the back diffusion became dominant, resulting in the dissolution of the salt crystals as the gap between the convective and diffusive salt flux narrowed. A total of 641 mg of salt (average of 40 mg per tree) accumulated after 24 hours, which is only 8% of the salt from the vaporized salt water. The rest of the salt dissolved back into the feed water, which can be assumed to be nearly infinite when implementing this device in a natural waterbody such as the ocean. Therefore, diffusion-enabled self-cleaning was found to be an effective strategy for preventing NaCl precipitation buildup. A major limitation of such self-cleaning mechanism is the trade-off between the water-lifting height and the long diffusion pathlength. Therefore, a larger surface area for passive evaporation should be achieved through alternative strategies including maximizing the capillary water-lifting height, increasing the packing density of trees in the lattice, and constructing microstructures on the evaporator surfaces. Moreover, the presence of sparingly soluble salts such as gypsum and calcite may require an active cleaning strategy such as washing or the dosage of antiscalant.

The evaporation performance and self-cleaning mechanisms of the engineered 3D evaporators have been demonstrated under controlled solar irradiation and environmental conditions. However, field application of such desalination devices would require reliable operation under more complicated weather conditions such as cloud coverage, the movement of solar angles, and the change of environmental temperatures. To further evaluate the performance of the system, a prototype device with both vapor generation and condensation chambers was tested for 48 hours on a rooftop. A solar-powered fan was installed on the sidewall of the vapor generation chamber, which provided ˜1 m/s airflow through the 4×4 engineered 3D evaporator lattice into the vapor condensation chamber. The airflow not only enhanced convection, but more importantly drew in ambient air with lower humidity and higher temperature to sustain a high evaporation potential. The vapor generation rate was affected by the daily cycles of solar irradiation and air temperature. During the daytime, a maximum evaporation rate of ˜5 LMH was measured for the two consecutive days, which was comparable to the ideal performance in the laboratory. However, due to the rapid increase of relative humidity in the ambient environment after sunset, the evaporation rate dropped below 1 LMH during the night. Based on the proposed salt precipitation model, salt back diffusion would inverse the net salt flux when the evaporation rate is less than 3 LMH. Indeed, a faster convective salt flux was found based on the evaporation rate between 12 pm and 6 pm as compared to the back diffusion which was calculated by the concentration change in the feed tank.

However, the back diffusion kept almost constant and surpassed convective salt flux during the night time and early morning due to the reduced evaporation rate. A total of 361 mg salt accumulation (half of that during the intermittent operation in the lab) was found after the two-day operation and no visible salt buildup was observed. A total of 83 mL of distilled water was collected during the two days, which was around 70% of the total evaporated water. The loss of water vapor was likely due to the heat accumulation in the condensation chamber and the unrefined system design. A higher condensation efficiency could be pursued by providing additional heat sink (e.g., seawater) and creating air circulations in the system. Nevertheless, each square meter of such an engineered 3D evaporator lattice can produce over 15 liters of distilled water which meets the drinking fluid requirement for a family of five.

To decouple the energy contributions in the field test, the solar intensity, relative humidity, and air and surface temperatures were monitored. Solar irradiation increased after sunrise to a maximum of ˜800 W/m² at noon and then decreased to a minimum at sunset. In contrast, the evaporation rate peaked in the afternoon at around 3:00 PM when the ambient air temperature reached the highest of the day. Due to the difference in the daily cycles of solar irradiation and air temperature (also known as the daily temperature lag), the energy contribution available for vaporization varies accordingly. Solar irradiation was the major energy source during the morning times when the air temperature was low and relative humidity was high. As the air temperature rose in the afternoon, the ambient heat in the air became the dominating energy source. In general, solar irradiation contributed 28% of the total energy for vaporization, slightly lower than that measured in the laboratory (i.e., 34%) due to cloud coverage and the changing solar angle.

### Example 2

Fourteen (14) spiral 3D evaporators were formed using natural cotton fiber as the raw material. For each evaporator, a bundle of cotton fibers was spun into a yarn with a diameter of 1 mm, and 4 yarns were further twisted into 1 cord with a diameter of 2 mm. The individual crystallizers were assembled into a circle array by hanging on a ring-shape holder, and the distance between each crystallizer was 2 cm. The other end of each evaporator was placed in collected seawater.

### Example 3

Critical minerals, such as lithium, have become a national security and sustainability priority due to the exponential demand of such materials for lithium-ion batteries and electric vehicles (EV). The U.S. currently only mines and processes <1% of the world's lithium, so securing domestic sources is therefore vital to national security. Currently almost all commercial lithium is sourced from ores and brines found on land. Evaporation of brine extraction has been a dominant process since the 1940s due to its lower cost compared to extraction from rock. For example, the famous SQM plant in Chile is the largest evaporation site, accounting for 25% of global Li production. Li-containing brine (0.013-0.2% Li concentration) is pumped to the surface and concentrated in evaporation ponds. Impurities such as Mg-T are removed by lime addition, and lithium carbonate (Li2CO3) is the final product after adding sodium carbonate (Na2CO3). The whole process can take more than 15 months and requires a large land area (e.g., ˜20 km²). Additionally, the operation is known to negatively impact local groundwater and ecosystems due to leaching of the saline brine.

As an alternative, the oceans contain ˜5,000-times more Li than what is found on land, with ˜230 billion tons of Li available. Extracting this critical mineral from ocean water could be a more sustainable approach for meeting growing Li needs, but the low concentration (e.g., ˜0.2 ppm vs. ˜20 ppm) makes traditional natural evaporation infeasible. Lab-scale methods have been reported via adsorption, strong acid ion exchange, electrodialysis, and electrochemical intercalation, but so far these approaches have suffered from low selectivity, limited throughput, high cost, and poor scalability. For example, a pulsed electrochemical intercalation process using a TiO2-coated FePO4 electrode was reported to concentrate Li by ˜18,000-fold from seawater, but the electrode needs to be replaced every ˜100-1,000 seconds to maintain high faradaic efficiency, making it difficult to scale.

The disclosed approach allows for the development of highly efficient evaporators for Li extraction from water, sediment, or soil using ecofriendly materials. A preliminary study has demonstrated successful Li extraction from seawater as an example using a non-optimized long and mesoporous natural cotton fiber crystallizer, which showed the ability to lift seawater by 0.6 m via the capillary force for rapid water evaporation at a rate of ˜20 kg·m⁻²·h⁻¹ under a wind speed of 0.5 m·s⁻¹. Due to the solubility differences between Li and Na salts, the continuous siphoning and evaporation of seawater through the fibrous crystallizer results in non-uniform salt precipitation along both the radial and axial directions (i.e., compared to the Na salt, Li salt is richer in the middle than on the outside of the fiber, and is richer on the top than at the bottom), thereby spatially separating Li from Na with a selectivity ratio of from 10 to higher to 5000. This is among the most flexible and highest separation ratios from evaporation-based approaches.

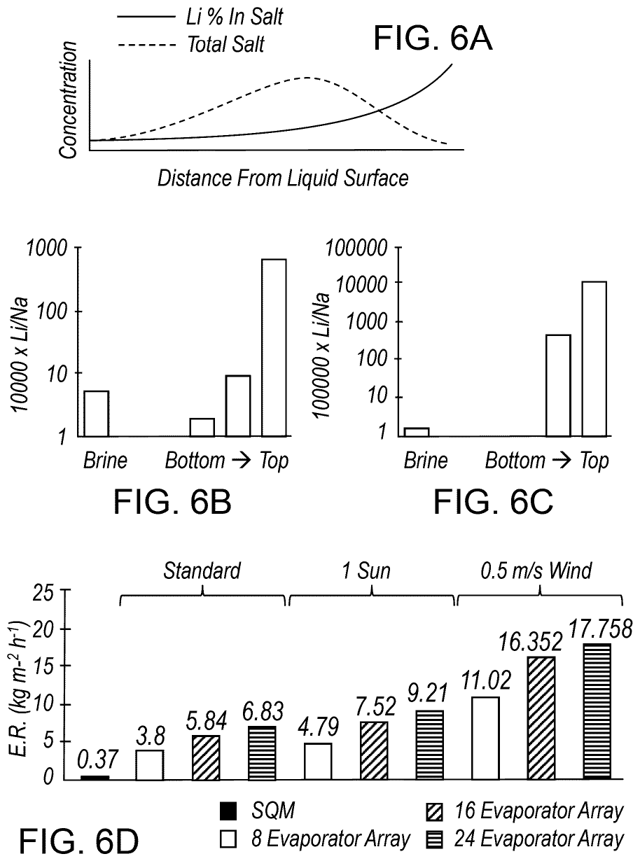

Specifically, lithium extraction from low concentration seawater can be realized by the solubility differences between multiple cation species, especially when considering the high solubility of lithium ions compared to other ions, including sodium, magnesium, and potassium (see FIG. 6A). Also demonstrated was the fabrication of hydrophilic, vertically aligned, porous crystallizer that use the capillary force to draw up seawater and crystallize different salt species at different heights based on their local concentration. Salts with lower solubility will crystallize at lower heights, while salts with a higher solubility, like Li ions, will crystallize near the top of the crystallizer (see, e.g., FIG. 4, where a first region (such as that represented by salt 405) may be Na-rich portion, and a second region (such as that represented by salt 407) may be Li-rich region. As a result, different ions will precipitate sequentially on the 3D structure (i.e., with both radial and axial structures), with Li ions concentrated and separated at the top position.

Preliminary results using a porous cellulose fibrous crystallizer confirmed such distribution and separation. It was found that the 3D crystallizer could increase the Li/Na ratio by >100-fold from typical brine (˜0.05% Li/Na) so that lithium was extracted to the top 2 cm section of a 50 cm long evaporator. The extraction was even more effective for seawater (0.0015% Li/Na), from which the crystallizer was able to increase the Li/Na ratio by >5000-times at the top section of the crystallizer. See FIGS. 6B and 6C. In contrast, most of the Na-rich salt crystals accumulated in the middle section (30˜40 cm) of the fiber. These salt crystals formed a solid shell outside of the crystallizer structure, which can be easily separated (e.g., by gently pulling the shell off the evaporator). In this example, the tall and slender 3D evaporator has a high length/radius ratio of ˜600, which offers a high surface area to accelerate water evaporation.

Additionally, it was found that in these examples, a common outdoor environmental driving force like solar energy can increase the evaporation rate by up to ˜18-times compared to the existing evaporation ponds in the world's largest brine Li extraction plant (SQM, Salar de Atacama, Chile). When aided by 0.5 m/s wind, the evaporation rate further increases to ˜18 kg·m²·h⁻¹, or 50 times that of the SQM evaporation ponds. See FIG. 4D. These findings suggest that the Li extraction processing time can be significantly shortened from >15 months to <10 days compared to existing evaporation ponds.

3D X-rays were utilized to scan the crystals formed outside the crystallizer surface. Results showed that surface drying induced strong advection and showed the distribution of the salt ions in both the liquid and solid phase. A finer scanning result showed the uneven density distribution of the salt crystals generated on the 3D crystallizer structure, indicating the distribution of Li- and Na-salts since they have different elemental masses.

Also used was electron energy loss spectroscopy (EELS) combining with S/TEM to estimate the distribution of Li collected from the crystallizer. The sensitivity of EELS for Li is sufficiently high (0.2 wt. %) with the excitation of low energy loss appearing at 55 eV (Li K-edge). EELS in combination with high-resolution S/TEM has significant advantages in terms of sub-nm spatial resolution at the optimized operation conditions. The existence of Li in the peripheral region of the evaporator was verified. It is hypothesized that there is a clear boundary between NaCl and LiCl, suggesting that NaCl was first precipitated from solution to form a large particle and then LiCl precipitated in the peripheral region. From preliminary tests, it is clear that by combining 3D X-ray and S/TEM-EELS, one can gain comprehensive understanding of the distribution and amount of Li in the salt crystals generated on the 3D crystallizer, which will greatly help with modeling and system development. Moreover, it is an aim to reveal the real-time crystallization mechanism via temporal resolution using tools like in situ IR nano-spectroscopy and/or time-of-flight secondary ion mass spectrometry (ToF-SIMS).

### Example 4

The base material used for fabricating the 3D spatial crystallizer was natural cellulose fiber yarn with a measured diameter of 2 mm. The cellulose fiber yarn was cut into 70-cm pieces and was then soaked in DI water for 4 hours to remove air bubbles in the pores to provide good liquid-solid contact along the whole structure. The fully wetted fiber crystallizer was then arranged vertically with the bottom ˜3 cm soaked in the saline water source with continuous replenishment during the experiment. After an extraction cycle, the crystallizer was cut into 2-4 cm pieces along the height and dried in a vacuum oven at 40° C. for over 24 hours to fully remove the moisture. The easy-peeling salt shells were removed from the structure and dissolved in DI water for tests. Each individual crystallizer piece was also soaked in DI water seperately for over 24 hours to guarantee all ions released to the solution. The water samples were then diluted appropriately, and the ion concentrations were tested by the Inductively Coupled Plasma (ICP) after filtration by PVDF syringe filters (25 mm, 0.45 μm). Specifically, the Li⁺ and Na⁺ concentrations in all samples were measured by the Thermo Scientific iCAP RQ ICP-MS operated in the STD mode with 1550 W plasma power and a carrier flow of 1.1 L/min nebulizer gas. To avoid errors caused by dilution, duplicate samples with different dilution ratios were tested for each sample.

Two synthetic saline water conditions were used for testing the Li extraction. Seawater condition was based on the typical ocean composition: c(Li+)=0.18 ppm and c(Na+)=10800 ppm. Brine condition was based on the typical geothermal brine composition at Salar de Atacama, Chile: c(Li+)=1500 ppm and c(Na+)=76000 ppm.

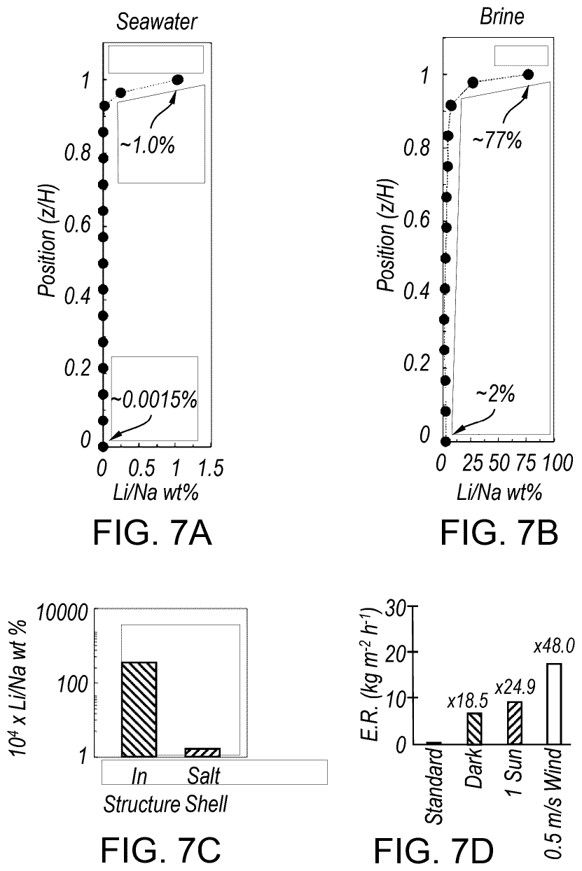

The sequential and separable crystallization of lithium from multiple cation species of different initial concentrations and solubilities is made possible by capillary and evaporative flows within the fiber crystallizer. The porous structure can raise water by ˜0.6 m via the capillary force and allows for much faster water evaporation on the side surfaces. As water evaporates, salts with higher concentrations and lower solubilities, like NaCl, crystallize at lower heights of the fiber crystallizer, while salts with lower concentrations and higher solubilities, like LiCl, move further upward and crystallize near the top. As a result, with sufficient height of the twisted fiber structure, different salts reach their saturation points at different locations and precipitate sequentially along the crystallizer length, providing enough spatial separation for recovery. FIG. 7A shows that during evaporation operation Li/Na wt. ratio gradually increases along with the height (H) of the crystallizer, and after 60-hours the Li/Na ratio at the top 10% section of the crystallizer is >675-times (1.0%) higher than the background bulk seawater (0.0015%). A similar trend in Li accumulation is observed when using typical continental Li-containing brine as well (see FIG. 7B), with the crystallizer concentrated Li by >39 times (77% vs. 2%).

The spatial separation was also observed along the radial direction (R), with a Na-rich salt shell formed outside the crystallizer. Compared with a very high Na content in the salt shell, the Li/Na ratio was >200 times higher inside the crystallizer structure. See FIG. 7C. This enables easy physical separation of the Na salts from the crystallizer and further facilitates the recovery of the concentrated Li in the porous structure. This spatial separation is a result of ion re-distribution within the porous material, which is influenced by the competition between advection (induced by water evaporation and capillary flow) and diffusion (induced by an ion concentration gradient). With a high evaporation rate at the surfaces of the crystallizer, advection is dominant, and salts with higher concentration (NaCl) reach saturation first and crystallize at the air/solid interface where drying occurs. When the drying of the water expands from outside to the center, amorphous Li salts start to crystallize in the center section. This spatial distribution of the different salt crystals allows the selective accumulation and separation of lithium from other cations.

In this example, the crystallizer features a very high height/radius (H/R) ratio of ˜600, which enables a large surface area and fast evaporation rate (E.R.). A single device (projected area of 0.031 cm²) under an ambient laboratory condition (20° C., 40% humidity, 0 m/s wind, indoor light) showed a E.R. as high as 220 kg/(m²·h). In addition, when an array of 24 crystallizers were constructed (projected area=64 cm²), a normalized E.R. of 6.8 kg/(m²·h) was obtained based on the projected area containing interspaces. This is more than 18-times faster than the values reported by the largest evaporation ponds for lithium extraction (3200 mm/year, SQM, Salar de Atacama, Chile) (17). Moreover, when aided with natural solar irradiation (1 sun) or wind (0.5 m/s), the E.R. was further accelerated to 9.2 and 17.8 kg/(m²·h), respectively (see FIG. 7D). This suggests that the system can be >50-times faster in rate than the evaporation ponds, greatly shortening the operation time, potentially from >15 months to <15 days if properly scaled up.

The demonstrated crystallizer is made from natural cellulose fibers fabricated with four twisted strings. A 3D X-ray scanning image shows the cross section of the 3D structure, where four strings are twisted tightly with an angle of 23˜24° to the vertical. When a 70 cm long crystallizer was partially dipped in saline water, evaporation occurs continuously along the water lifting height (H). It was observed that most of the NaCl crystals formed surrounding the surface of the structure at around ⅓ height, while salt layers became gradually thinner upward.

To decipher the composition and the mechanisms of sequential crystallization of different salt species, the salt density distribution was characterized on two representative sections, one is on the very top (location 1) and another is at the top of the thickest salt accumulation (location 2). The 3D X-ray images reveal the very different salt densities and distributions between the two locations. The most observable difference is that in the longitudinal (H) direction, the salt density was much higher at the lower location 2 than the upper location 1, as evidenced by the color change from red to blue in the 3D x-ray images. In addition, there is a gradient in density in the radial (R) direction, with colder colors indicating lower densities inside the structure, while warmer colors show higher densities outside the structure. This supports the hypothesis that Li salt (with smaller molar mass) is enriched inside the structure, while Na salt (with larger molar mass) is enriched outside the surface. This distribution was further confirmed by other advanced elemental scanning methods. Overall, along the H direction, much higher Li content was identified on the very top location (Li/Na mass >77%), while lower Li but higher Na content (Li/Na mass of 1.0˜4.3%) was found in the lower 0.85 H section, with large NaCl cubic crystals dominating the formation of a thick salt shell.

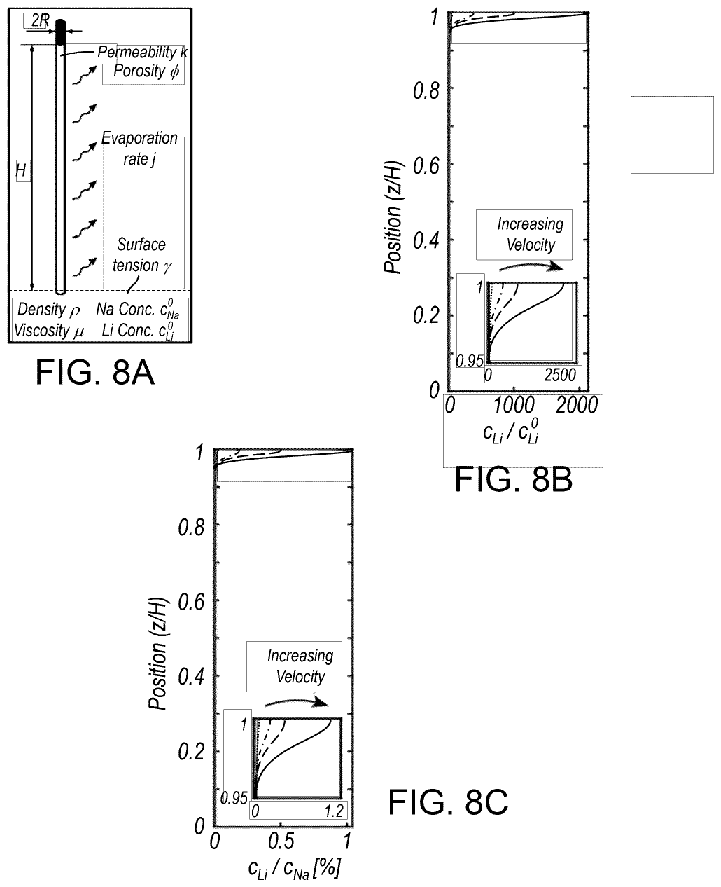

A mechanistic model was developed to describe the ion transport inside the slender porous cylindrical structure, which continuously draws liquid from the reservoir and evaporates along its length. See FIG. 8A. The model predicts the concentration of Na (c_{Na}) or Li ions (c_{Li}) as a function of time t and the position z along the water lifting height, H, (see, e.g., FIGS. 8B, 8C). The radius of the crystallizer is R and ρ is the solution density, while the ions have concentrations c_{Li}⁰, G_{Na}⁰ in the bulk solution and c_{Li}^{sat}, c_{Na}^{sat} at saturation. The predicted concentrations critically depend on the effective Péclet number Pe=jH²/(ρDR), a dimensionless parameter quantifying the ratio between advection (driven by the evaporation rate j) and diffusion (quantified by the ion diffusivity D). Given a very high aspect ratio between the lifted height H and the radius R of the evaporator, advection is dominant over diffusion and Pe>>1, causing an exponentially fast increase of the concentration of both ions at the top of the evaporator, c(z=H)=c⁰e^{2tj/(ρR)}. Such a sharp buildup of concentration, combined with the fact that Na is much closer to saturation in the bulk solution (c_{Na}⁰/c_{Na}^{sat}>>c_{Li}⁰/c_{Li}^{sat}), leads to rapid precipitation of sodium, which crystallizes first. Consequently, after a characteristic time (ρR/2j)ln (c_{Na}^{sat}/c_{Na}⁰), the Na concentration remains constant at the top of the evaporator, in equilibrium with the NaCl salt. This allows Li, which is comparatively further from saturation, to increase its relative concentration (FIG. 8C) as evaporation keeps driving the solution through the porous NaCl salt shell. Model results are consistent with our experimental observations (see FIGS. 7A-7B), showing also a pronounced buildup of Li mostly at the top 10% of the wet evaporator.

The experimental results support the hypothesis that in the radial direction (R), NaCl crystallizes outside the structure while LiCl concentrates in the center section. This is further supported by the cross-section Scanning Electron Microscopy (SEM) with Energy Dispersive X-Ray Analysis (EDX) scanning results, where the Na elemental map shows a circular shape surrounding the crystallizer structure and the Li map shows a dispersed distribution across the crystallizer's cross-section. When focusing on the area between the fibers and salt crystals, only the salt crystals exhibit clear Na spectra, while the fibers showed no Na signal. In contrast, the Li spectra was detected across the fiber areas, with the weakest signal at the bottom-right corner, where the NaCl crystals are located. Thus, NaCl crystals formed outside on the fiber, while LiCl formed amorphous salts across the fiber. Such a spatial distribution allows extraction and separation of Li and Na individually in practice, which is demonstrated in crystallizer array testing.

The salt crystal morphology can be characterized to understand the dynamics of ion re-distribution and crystal formation. The SEM-EDX investigations of a sub-millimeter-scale salt cluster were undertaken, and electron energy loss spectroscopy (EELS) combined with S/TEM was employed to investigate the crystal morphology and elemental distribution at the sub-micron scale. The S/TEM scanning images depict that square-shaped crystals are surrounded by amorphous crystals. A clear boundary can be observed between the two types of crystals in the zoom-in scan, indicating the presence of two different salt species. The EELS map confirmed this assumption, as Na was found distributed only at the right side of the boundary, with Li distributed mostly at the left side. On the other hand, Cl was present everywhere as a counterion. These results confirm that central square-shaped crystals are NaCl, while LiCl formed the amorphous crystals in the peripheral region. The clear boundary between Na and Li suggests a sequential rather than a concurrent crystallization. Because NaCl has a lower solubility and higher concentration, it is reasonable that NaCl crystallizes first, while LiCl is prone to nucleate around those NaCl cores gradually when saline water dries out at the location. For the salt particles sampled from the salt shell outside the fiber structure, we did not observe any EELS spectra of Li. This confirms that most Li are localized inside the mesoporous fiber structure during sequential crystallization.

The 3D twisted fiber crystallizer enables lithium separation by providing a high aspect ratio and surface area that allows staged crystallization of different salt species. The twisting structure further enhanced such features, as the spiral structure provides suitable porosities and pathways for saline water to move upwards, drying and crystallizing along the way.

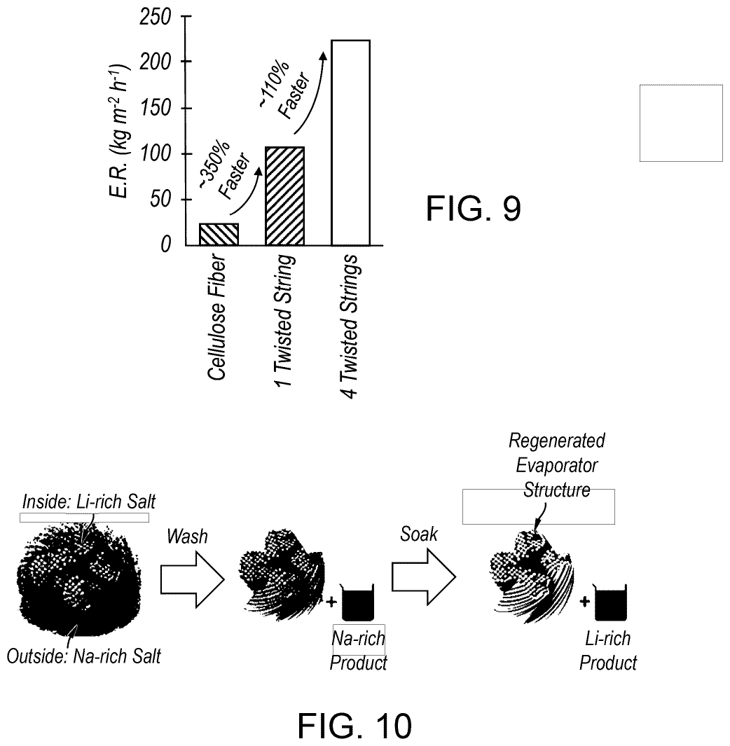

The structure was fabricated by firstly spinning the natural cellulose fibers into a tight string (diameter=1 mm), then further twisting four strings together to provide a structure with a diameter of 2 mm. For better comparison, cellulose fibers were also aligned to form a linear structure, with a diameter of 1.2 mm. Compared with the non-twisted control, the single twisted string lifted water by 102% higher, and the 4-strings twist further increased the lifting by another 57%. Such twisting is believed to lead to a larger suction force to lift water higher, and as a result, a 351% increase in water evaporation was observed by the single twisted string compared with the untwisted string, and 108% increase in evaporation by the 4-string twist (see FIG. 9).

In some embodiments, n-string twists may be used, where n>1. For example, n=4, n=5, n=6, n=7, n=10, n=16, n=100, etc. A lab test also showed adding each pair of twisted strands may continue improving water lift by ˜10-15%. This effect can be explained introducing a model for the lifting height H, which results from a balance of capillary pressure (inducing an upward flow at the pore scale) and gravity (pulling the fluid downward). Typically, the lifting height produced by capillary forces can be modeled as H=γ\sqrt{ϕ}/(ρg\sqrt{k}), with γ the surface tension coefficient, g the acceleration of gravity and ϕ and k the medium porosity and permeability (respectively). Increasing the packing of fibers and strings by twisting would reduce their spacing and thus the effective pore size of the heterogeneous evaporator. Since the permeability k is directly proportional to the characteristic pore size of the medium, twisting could ultimately result in smaller permeabilities and larger values of the lifting height.

In this example, the scalability of these fiber crystallizers was also analyzed by constructing and testing a prototype array consisting of 100 fiber crystallizers (aka evaporator structures). The fiber crystallizers were arranged on a plastic mesh so they can be spaced evenly with the bottom section soaked in saline water. Since NaCl would preferentially crystalize at the air-liquid interface, the formed Na-rich salt shells could be harvested by gentle vibration or scraping. In contrast, LiCl tends to form crystalline hydrate as water evaporates and stays within the crystallizer. Therefore, a wash-soak method (as illustrated in FIG. 10) was implemented to recover the Li-rich concentrate. The Li/Na wt. ratio in the recovered concentrate was found to be 55-105% higher than the preconcentrated Li brine in the conventional practice. Meanwhile, the crystallizer was regenerated and can be readily used for the next crystallizing cycle. Such a process may save over 90% of the land use to reach a comparable yearly lithium production capacity of the SQM plant in Chile (˜2.4 kt/km²·y), which has significant advantage for regions with limited space and environmental concerns. Furthermore, since the evaporator structures draw thermal energy mostly from the ambient heat of air rather than direct solar irradiation, they have the potential of being stacked to further reduce the overall system footprint.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

1. A process for water, organics, and/or mineral recovery comprising:
providing a plurality of evaporator structures comprising a porous material, each evaporator structure having a first end and a second end opposite the first end separated by an axial length, each evaporator structure being physically separated from an adjacent evaporator structure;
contacting the first end of each evaporator structure with a liquid, the liquid comprising a plurality of materials, the plurality of materials including a solvent and at least one target material at a first concentration;
allowing capillary forces or siphonic action to draw at least one material of the plurality of materials from the first end towards the second end; and
evaporating one or more of the plurality of materials by transferring at least one form of environmental energy directly to each evaporator structure, thereby providing a latent heat of vaporization.

2. The process according to claim 1, further comprising collecting the at least one target material after the at least one target material passes from the first end to the second end.

3. The process according to claim 2, further comprising determining a concentration of the at least one target material being collected.

4. The process according to claim 3, further comprising adjusting a distance from the second end to a collection reservoir based on determined concentration.

5. The process according to claim 1, wherein each evaporator structure includes a plurality of fibers twisted around each other to form a spiral pattern having at least a first pitch, and wherein the process further comprises adjusting a pore size of at least a portion of a evaporator structure of the plurality of evaporator structures by rotating a first portion of the evaporator structure around a central axis relative to a second portion of the evaporator structure, causing the first pitch to be changed to a second pitch different from the first pitch.

6-7. (canceled)

8. The process according to claim 1, wherein the liquid is a saline water source.

9-10. (canceled)

11. The process according to claim 8, wherein the at least one material is water, and the process further comprises capturing and condensing the water.

12-13. (canceled)

14. The process according to claim 1, wherein the at least one target material is lithium.

15. The process according to claim 11, further comprising allowing the capillary forces or siphonic action to spatially separate salts in the liquid by their differences in solubility, hydrophilicity, mobility, charges, polarity, and local concentration.

16. The process according to claim 15, further comprising evaporating water and crystallizing a plurality of salts in or on a porous crystallizer, where salts with different solubilities are separated spatially similar as a chromatographic separation, such that high solubility salts move further in distance from the first end.

17. The process according to claim 15, further comprising evaporating water and transporting a plurality of salts in or on a porous crystallizer, where salts with lower solubility move at a first speed from the first end, while salts with a higher solubility move at a second speed greater than the first speed from the first end, and when not crystallized on the porous crystallizer, the salts with different solubility, mobility, or charges pass through the porous crystallizer and collected as solute at an end of the porous crystallizer.

18. The process according to claim 15, further comprising evaporating water and crystallizing a plurality of salts in or on a porous crystallizer, where salts with lower solubility are crystallized within a first distance from the first end, while salts with a higher solubility are crystallized after the first distance and before a second distance from the first end, the second distance being greater than the first distance, such that different salts precipitate sequentially on the porous crystallizer with both radial and axial structures.

19. The process according to claim 18, further comprising collecting a first salt that crystallized at or near the second end, and separately collecting a second salt that crystalized at or near the first end.

20-41. (canceled)

42. The process according to claim 1, further comprising applying an electrical or magnetic field on the plurality of evaporator structures.

43. The process according to claim 1, further comprising removing at least one of the plurality of evaporator structures from the liquid.

44. The process according to claim 43, further comprising washing each evaporator structure that has been removed.

45. (canceled)

46. The process according to claim 43, further comprising placing the first end of a new evaporator structure into the liquid after the at least one of the plurality of evaporator structures has been removed from the liquid.

47. The process according to claim 43, wherein removing at least one of the plurality of evaporator structures from the liquid comprises simultaneously removing two or more of the plurality of evaporator structures from the liquid.

48. An apparatus for water, organic, and/or mineral recovery, comprising: a plurality of evaporator structures, each evaporator structure comprising a porous material, each evaporator structure having a first end and a second end opposite the first end separated by an axial length, each evaporator structure being physically separated from an adjacent evaporator structure, where each evaporator structure has a porous structure configured to use capillary forces to draw a liquid from the first end towards the second end; wherein the apparatus is configured to allow at least one form of environmental energy to be transferred directly as latent heat for vaporization to each evaporator structure.

49-75. (canceled)

76. A evaporator structure, comprising:
a plurality of flexible elongate members, each flexible elongate member twisted together to form a spiral pattern, each flexible elongate member comprising a porous material, each flexible elongate member having a first end and a second end opposite the first end and separated by an axial length, the porous material being configured to use capillary forces to draw a liquid from the first end towards the second end; wherein each flexible elongate member has an axial length of at least one meter.

77-82. (canceled)
